(19) United States
(12) Patent Application Publication
(10) Pub. No.: US 2004/0055699 A1
(43) Pub. Date: Mar. 25, 2004

(54) Method for accelerated bondline curing

(76) Inventors: Faye C. Smith, London (GB); Alan D. Gardner, Darien, CT (US); Andrew J. Miller, Bedfordshire (GB)

Correspondence Address: WHITE & CASE LLP, PATENT DEPARTMENT, 1155 AVENUE OF THE AMERICAS, NEW YORK, NY, 10036, US

(21) Appl. No.: 10/607,422

(22) Filed: Jun. 25, 2003

Related U.S. Application Data
(60) Provisional application No. 60/392,416, filed on Jun. 28, 2002.

(51) Int. Cl. B32B 31/00

(52) U.S. Cl. 156/273.9

(57) ABSTRACT

A method is provided for accelerating the curing of an adhesive at a bondline while bonding structures using a fabric heater. The method comprises applying an electrically conductive fabric heater between structures to be bonded to which a layer of adhesives is applied to the bonding surfaces of the structures. Once the adhesive layers and fabric heater are applied to the bondline, pressure is applied and the heater is energized to produce heat uniformly throughout the bondline at the curing temperature of the adhesive so that the adhesive is evenly or symmetrically cured. After curing the adhesive, the heater remains sandwiched at the bondline to act as a reinforcing fabric.

### CROSS-REFERENCE TO RELATED APPLICATION

This application claims the benefit of U.S. Provisional Patent Application No. 60/392,416, filed on Jun. 28, 2002.

### TECHNICAL FIELD OF THE INVENTION

The invention relates to a method for accelerating the curing of an adhesive at a bondline for bonding structures. In accordance with the invention, a heater comprising an electrically conductive fabric is applied at a bondline between facing bonding surfaces layered with an adhesive, wherein the heater provides heat necessary to cure the adhesive to bond the surfaces together, and acts as a reinforcing layer when the curing/heating process is complete.

### BACKGROUND OF INVENTION

The design and manufacturing of multi-component structures have increasingly relied upon the use of composites and, more specifically, the joining of component parts by adhesives as opposed to fasteners. Joining substrates or structures using adhesives has increased production throughput and allowed engineers to design larger and more complex parts. However, as these multi-component structures become bigger and more complex, the processes or methods presently used to build such structures using adhesives demand increased amounts of time and higher costs to the industry. One area of difficulty with such designs lies in the time and equipment required for the adhesives to properly cure.

As the popularity of adhesive-joining methods and the demand for shorter cure times continue to grow, the adhesive manufacturing industry is providing products suitable for accelerating the curing processes, i.e., accelerating the curing time of the adhesive by elevating the temperatures locally. Until now, such acceleration has taken the form of an “oven curing for large components method,” or by curing using “induction heating.” Oven curing is accomplished by placing the complex, multi-components part in a large oven at the curing temperature of the adhesive. Alternatively, induction heating is designed for smaller, more manageable parts and the heating of the adhesive is accomplished by inducing heat locally using an induction apparatus placed at a distance from the object. The disadvantages of such methods are numerous.

Specifically, the costs associated with accelerated curing of adhesives in ovens, particularly those related to the aerospace market, can be attributed to some or all of the following inefficiencies: wasted energy consumed by the oven structure and surroundings; wasted energy in heating the entire part; the capital expenditure for the oven itself; potential deformation of the component material, and periodic maintenance of the oven.

Induction methods incur high costs as well, although not always recurring. The two major components of an induction coil device, i.e., coil design and frequency generating circuits, are designed in concert with one another. Because no single coil design can perform satisfactory for every joining operation, the user must be able to select from several available designs. Therefore, consideration must be given to individual systems for different operations. In some instances, expensive systems offering interchangeable coil designs must be used. In addition to the coil and frequency generator, the electromagnetic interference and radio-frequency interference ratio (EMI/RFI) shielding necessary for induction coil heating devices can add considerable cost to the machine.

In addition to the cost and inefficiencies associated with the use of ovens or induction methods, both have inherent deficiencies in heating flexibility and/or temperature control. While an oven can be built to accommodate large structures, it does not have the flexibility to provide discrete area heating. A case in point would be a component previously installed within an assembly but which is not able to withstand the elevated temperatures necessary for the current curing cycle. Induction methods, however, can be used around a small object or over a large surface in a local/roaming fashion over a large surface. Nevertheless, the use of induction methods is limited by the necessity to be within a specific distance from the susceptor, a circumstance unlikely for complex geometries, not to mention the non-uniform field generated by such use.

Furthermore, some induction methods, for example, those outlined in U.S. Pat. No. 6,043,469 to Fink et al., U.S. Pat. No. 5,075,034 to Wanthal, and U.S. Pat. No. 6,056,844 to Guiles, require the introduction of materials within the bonding agent which, disadvantageously, are detrimental to the strength of the bond. Fink et al. use metallic mesh “susceptors” to aide in the development of eddy currents, providing heat to achieve the bond. In a similar manner, Wanthal and Guiles depend on conductive particles within the thermoset adhesive used to produce the same result, each reducing the effective bond properties of the adhesives.

Whereas the aforementioned prior art degrades the bonding agent, U.S. Pat. No. 5,389,184 to Jacaruso and U.S. Pat. No. 5,498,443 to Sobol disclose methods of bonding structures which result in bondline thicknesses of 0.012 inches to 0.020 inches or greater. Bondline thicknesses of these magnitude are known to be detrimental to joint strength.

The use of carbon fibers within a bondline for curing adhesives is known to those skilled in the art. For example, U.S. Pat. No. 5,225,025 to Lambing discloses a method for curing adhesives which makes use of unidirectional carbon fibers within a polymeric matrix, which act as a resistive element to aid in bonding thermoplastic structures. The use of unidirectional fibers or carded fibers to cure adhesives, for example as disclosed in U.S. Pat. No. 3,627,988 to Romaniec, results in asymmetric curing properties at the bondline, such as joint strength in one direction. The present method seeks to overcome the disadvantages encountered in the prior art, by replacing the complex and expensive apparatuses necessary for oven or induction heating when joining two or more substrates or structures with a simpler technique.

### SUMMARY OF INVENTION

The present invention provides a method for accelerating the curing of an adhesive at a bondline between surfaces to be bonded, which improves the bond properties. Specifically, the method comprises disposing or applying a heater at the bondline, wherein the heater comprises an electrically conductive fabric of minimal thickness to the joint. The heater when energized generates heat locally at the bondline and accelerates curing of bondline adhesives, thereby achieving optimum joint properties once the adhesive is cured.

In the method of the invention, a thin resistive heater comprising an electrically conductive fabric is disposed between the structures to be joined. A curable adhesive is applied to the surfaces to be joined or to the electrically conductive fabric prior to joining, and a simple control system is attached to the fabric so that the temperature can be regulated. Furthermore, the present method of curing adhesives improves the bondline properties, such as bond strength and evenness of the cured adhesive, by providing a woven or non-woven fabric at the bondline which distributes heat evenly at the joint and acts as a fibrous reinforcement.

The method for bonding structures can be applied to at least two structures to be bonded having at least one bondline, wherein the method comprises:

applying a first adhesive layer on the surface of a first structure to be bonded;

applying a fabric heater on the adhesive layer on the surface of the first structure, wherein the fabric heater comprises an electrically conductive fabric, two bus bars, and leads for connecting to a power source;

applying a second adhesive layer on the surface of a second structure to be bonded;

contacting the second adhesive layer on the surface of the second structure with the exposed surface of the fabric heater on the first structure so that the fabric heater is sandwiched between the first and second adhesive layers on the first and second structures to form the bondline, and

energizing the fabric heater to raise the temperature at the bondline to the curing temperature of the adhesive; wherein the fabric heater becomes part of the bonded structures after curing.

In an embodiment of the invention, the method for bonding structures having at least one bondline comprises:

applying a heater element to the bonding surfaces of at least two structures to be bonded, wherein the heater comprises an electrically conductive fabric, two bus bars, and the heater is pre-impregnated with an adhesive;

contacting electrical leads to the bus bars and connecting the electrical leads to a power source, wherein the heater is sandwiched between the structures to be bonded, and

energizing the heater to produce heat evenly throughout the adhesive and to increase the local temperature of the bondline to the curing temperature of the adhesive; wherein the heater element becomes part of the bonded structure after curing.

Advantageously, therefore, the present invention provides a method of accelerating bondline curing wherein the heater provides an energy source in the curing process and, when bonding is complete, the heater acts as a fibrous reinforcement between the bonded layers. Accordingly, throughout the application, the heater is occasionally referred to as a “sacrificial” heater as it becomes part of the bonded composite structure after the heating/curing process is complete.

In as much as two, or more substrates of various shapes and sizes are to be joined, a lower substrate is prepared by abrasion, priming or the like and then is covered with a suitable adhesive of proper dimension, i.e., an adhesive covering only the intended area to be joined. The surface material can be any material including, but not limited to metals, thermoplastics, composites, such as carbon/kevlar, glass, and bricks. The resistive fabric element comprised of electrically conductive fabric with a thickness of between 0.001 inches and 0.008, but preferably between 0.002 inches and 0.005 inches, is disposed over the surface of the adhesive. The electrically conductive fabric is terminated at opposing ends by bus bars made out of, for example, metal strips such as copper, aluminum, brass, nickel and silver strips to provide an even distribution of current from an attached power supply. The location of the bus bars or metal strips, outlined in the detailed description with reference to the drawings, lies outside the bondline such that they may be removed once the curing cycle is complete. A second, upper substrate is similarly prepared by abrasion, priming or the like and then is covered with the adhesive.

The upper substrate with adhesive is disposed over the first and lower substrate such that the electrically conductive fabric element is sandwiched between the layers of adhesive. The final, heated dimension is such that only the intended area to be bonded is heated. Leads from a controlling power supply are attached to the metal strips on said heater with or without conductive adhesive, and positioned outside said substrates. Pressure can be applied to the assembly in the form of clamps, hydraulic press, vacuum bag or any means known in the art. After the assembly is formed with or without compression applied, the fabric element is energized from the power supply by a unit of variable voltage or current, either alternating or direct current. A suitable voltage is supplied across the resistive heater to induce the necessary current and rise in temperature for a prescribed time and rate to trigger an acceleration in the rate of curing the adhesive. The curing temperature applied to the bondline depends on the type of adhesive used and this information is usually supplied by the manufacturer. As the accelerated cure cycle progresses, the adhesive flows through and among the fibrous heater resulting in a unified, reinforced, composite structure. A thermocouple may be used to monitor the progress of the cure. A person of ordinary skill in the art is knowledgeable in the use of a thermocouple.

A surface treatment, such as a primer coat, can be applied to the substrates prior to bonding to aid in adhesion and improve the dielectric properties at the bondline of the substrate. For example, a chromic acid anodizing agent is applied to the substrate followed by the application of a bond primer, such Dexter Hysol 9210. Once the adhesive at the bondline is cured, the power source is turned off, the leads are removed and the bondline is allowed to cool. Once the bondline is cooled, the excess fabric is trimmed to the outside edges of the bondline and the bonding process is complete.

In an embodiment of the invention, the method for bondline curing comprises applying a heater element of the invention between the bonding surfaces of at least two structures to be bonded, wherein the heater is pre-impregnated with an adhesive and comprises an electrically conductive fabric and two bus bars. The heater is sandwiched between the surfaces to be bonded which have been previously primed as described above. Electrical leads are applied to the to each of the heater element, and connected to a power source. The heater is energized to produce heat evenly throughout the adhesive and to increase the local temperature at the bondline to the curing temperature of the adhesive. Once the adhesive is cured, the power source is turned off and the bondline is allow to cool. After cooling, the excess fabric heater(s) containing the bus bars is trimmed and the bonding is complete.

In another embodiment, one or more assemblies can be joined by the above methods or combinations thereof to form a unit structure. In accordance with this embodiment, each assembly is stacked to form a multiple layer bondline structure comprising two or more bondlines. In this embodiment, leads from the heaters at all bondlines are connected to the power source and the bondlines are cured as described above. The multiple bondlines can be cured simultaneously or sequentially depending on the structures to be bonded.

The invention is also directed to the products made using the methods of the invention. For example, products which require increased durability such as overhead storage bins in airplanes and buses or other forms of transportation, products for the aerospace industry and the like.

### BRIEF DESCRIPTION OF DRAWINGS

FIG. 1 illustrates a typical single, corner joint to be bonded with a sacrificial heater of the invention, wherein the heater is embedded in adhesive resin prior to bonding.

FIG. 2 shows a schematic representation of an embodiment of the invention which shows the bonding of two substrates with adhesive layers, resistive fabric heater and associated leads and power supply.

FIG. 3 shows a cross-section of the embodiment of FIG. 2 prior to trimming the excess portions of the heater outside the bondline.

FIG. 4 illustrates the cross section shown in FIG. 3 with the edges of the fabric heater trimmed.

FIG. 5 illustrates an alternative embodiment of the invention relating to electrically conductive substrates, also with associated leads and power supply.

FIG. 6 shows the cross section of an embodiment comprising an electrically conductive substrate prior to trimming.

FIG. 7 illustrates the method of the invention comprising a multiple bondline stack configuration.

FIG. 8 shows an alternate multiple bondline configuration with bondlines perpendicular to each other.

FIG. 9 is a photograph of an infrared image obtained during the heat-up or curing process of the invention.

FIG. 10 is a graph depicting the input voltage and cure cycle of using the method of the invention.

### DETAILED DESCRIPTION

The invention is directed to a method for accelerating the curing of adhesives at a bondline, comprising applying an adhesive layer on facing surfaces of a structure to be bonded and applying an electrically conductive fabric heater between the facing surfaces layered with an adhesive so that the fabric heater is sandwiched between the structures to be bonded. The assembly formed can be compressed and the heater is then energized to raise the temperature at the joint to the temperature at which the adhesive is cured. Once the adhesive is cured at the bondline, the heater is de-energized and the bondline is allowed to cool to room temperature, with or without the aid of a cooling chamber, depending on the composition of the structures bonded. The conductive fabric heater remains sandwiched between the bonded surfaces.

The fabric heater of the invention comprises a layer of electrically conductive fibers and it is very thin and light, and can be applied at the joint also enveloped in adhesive resin if the adhesive is not already applied to the surfaces of the structures to be bonded. The fabric heater can comprise any electrically conductive fabric made of various materials, which are known in the art and comprise naturally occurring or synthetic materials. The electrically conductive fabric or the fibers can be uncoated, or coated with a metal such as nickel, silver or gold. Coated and uncoated fibers can be used alone or in combination. In one embodiment of the invention the electrically conductive fabric is non-woven and comprises uncoated or nickel-coated carbon fibers.

In an embodiment of the invention, the fabric heater for use in the method, comprises a non-woven fabric, consisting of electrically conductive fibers, wherein the fabric comprises an organic or inorganic binder. In this aspect of the invention, the organic binder comprises, for example, a thermosetting polyester, and the inorganic binder comprises, for example, an alumina sol.

The method of the invention can be applied with any adhesive that can be cured at elevated temperatures which will be used at the bondline. These adhesives include, but are not limited to thermosetting, liquid, paste, and film adhesives such as SM300 and SM94 (Cytec Fiderit), Hysol 9330.3 (Hysol) and the like.

As illustrated in FIG. 1, the adhesive can be applied directly on the heater and the heater containing the adhesive 8 is applied to the facing or opposing surfaces of the structure 10 to be bonded. The heater is then connected to a power source and energized to reach the curing temperature of the adhesive. The heater is then de-energized and the assembly is allowed to cool. Thereafter, the excess fabric, if any, protruding through the bondline is trimmed to the edged of the bonded structures.

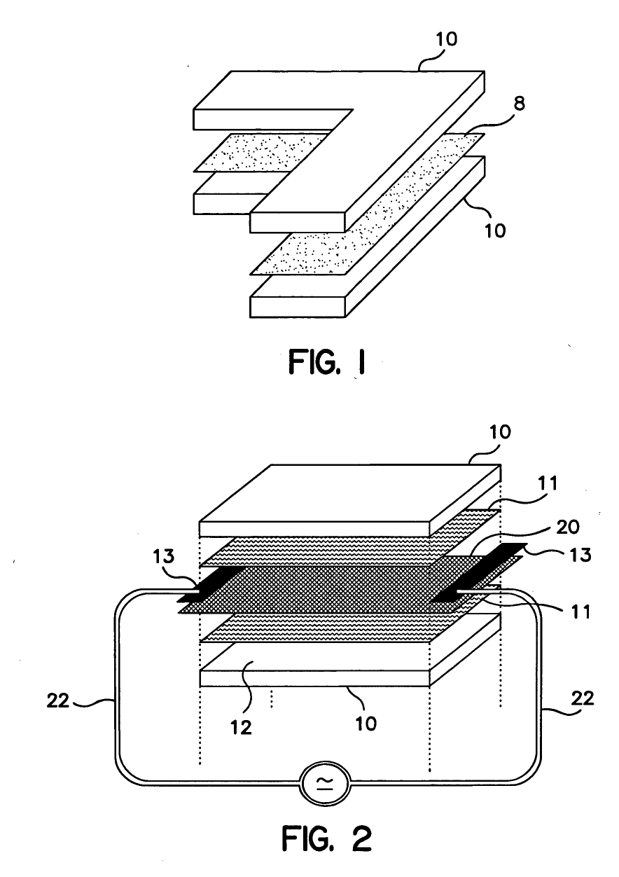

In another embodiment of the invention illustrated in FIG. 2, the substrates are composed of non-electrically conductive materials 10, to which a film adhesive 11, with or without a carrier, acting as an electrical insulator or not, is applied to the near and facing side of each of the two substrates 12. An electrically conductive, non-woven heating fabric 20 is sandwiched between the two substrates 12. Copper foils 13 placed at opposing ends provide an even distribution of current from the leads 22 attached to a power source.

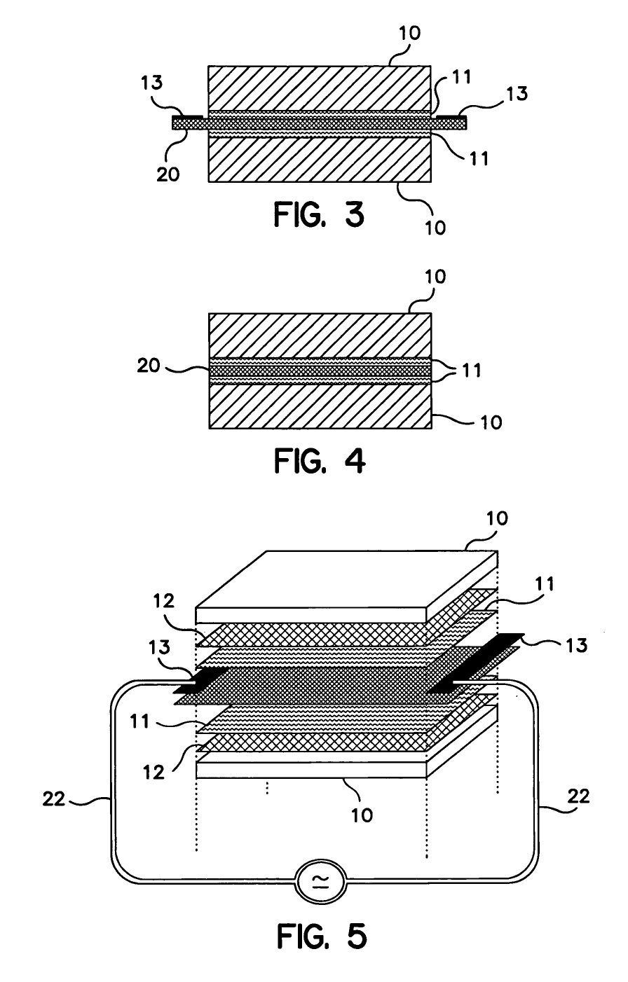

In this and other embodiments of the invention, the electrically conductive fabric heater comprises an electrically conductive, non-woven heating fabric. One of such fabric heaters is manufactured from randomly oriented, chopped carbon fibers in a paper making type process such as to produce a non-woven fabric of uniform character. The carbon fibers may be coated with a nickel coating on the order of 10 to 90 percent by weight, preferably 15 to 50 percent, is applied. One of these fabrics is marketed as Thermion® by Thermion Systems International. It has been found that the nickel coating results in an improvement over copper coating since its resistance to corrosion provides lower resistance, approximately 0.3 ohms per square, than the carbon alone, nearly 15 ohms per square, thereby allowing the use of less expensive power supplies 13 and virtually no requirement for high voltage safety measures associated with other high resistant heating types, while still providing benefits to bondline strength over metal foils or wires. FIG. 3 shows a cross section of this embodiment of the invention.

As shown in FIG. 3, the bondline comprises two layers of substrates 10, the fabric heater 20 with copper bus bars 13, and film adhesive layers 11. In this embodiment, shown immediately after bonding, the fabric heater is protruding from the bondline with the bus bars still attached. This example also depicts a single bondline cure. Any excess fabric heater protruding through the bondline after curing is trimmed to finish the process. The final trimmed component of FIG. 3 is shown in FIG. 4. Multiple bondlines can be cured by this method as discussed with reference to FIG. 7.

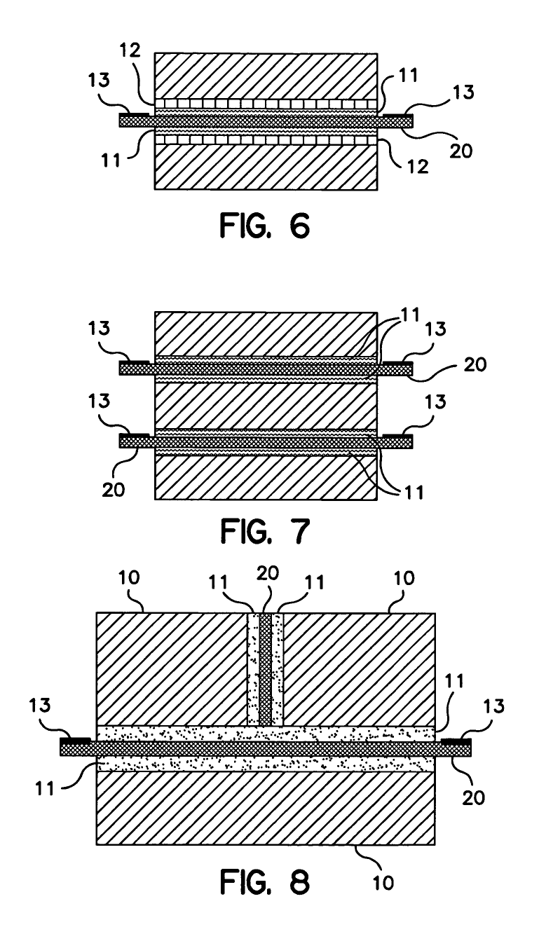

An alternative embodiment of the present invention is shown in FIG. 5. FIG. 5 also relates to an embodiment wherein the substrates 10 could be electrically conductive and the adhesive 11 lacks sufficient electrical insulation. In this embodiment, the substrate is insulated at the bondline by applying an insulating carrier or by treating the surface of the substrate with an agent to prevent shorting. For such cases, one or more layers 12, of insulating material, such as thin glass fabric, are disposed between the adhesive layer and each of the electrically conductive substrates. FIG. 6 shows a cross section of the embodiment shown in FIG. 5 immediately after bonding as shown with the bus bars 13, fabric heater 20 protruding from the bondline, adhesive layers 11, and one or more layers of insulating material, such as thin glass fabric.

FIG. 7 shows a multiple bondline curing arrangement. In this embodiment, layers of substrates 10, adhesive 11, and fabric heater 20 are arranged sequentially upon one another in order to accelerate curing of the multiple bondlines simultaneously. In this embodiment, each bonline is prepared as described above and the heaters can be energized simultaneously depending on the number of bondlines to be cured and the availability of power supplies or outlets.

FIG. 8 illustrates an alternative arrangement of a multiple bondline cure, wherein the bondlines are arranged perpendicular to one another. In this arrangement, the bus bars for the horizontal bondline 30 run into the plane of the paper, whereas the bus bars for the vertical bondline 31 runs vertical and parallel to same. In FIG. 8, the cross section does not show the latter. In this embodiment, each bondline is assembled and cured as described above with reference to the method for curing single bondlines.

In another embodiment of the invention, a vacuum bag (not shown in the drawings) is used for consolidation of the adhesive structure and intimacy of the metal bus to the conductive fabric, without the need for conductive adhesives or complicated jigs.

In another embodiment of the invention, the sacrificial fabric heater is pre-impregnated with the adhesive with or without the metal strips, thereby requiring only a single unit of heater and adhesive layer within the bondline.

### EXAMPLE 1

The following example illustrates a bonding process of the invention.

Two aluminum sheets of 0.125 inches in thickness, 15.0 inches in length, and 7.0 inches in width were treated with a dielectric primer on the bonding side surface and covered with a Cytec Fiberite FM94M 120° C. cure epoxy film adhesive, cut to the same dimensions. A Thermion® fabric heater of 10 g/m2 non-woven, carbon fiber fabric coated with 7 g/m2 nickel and cut to 16.0 inches by 7.0 inches was sandwiched between the adhesive layers ensuring 0.5 inches of the heater fabric was exposed at each end as the two aluminum sheets were brought together. Copper foil bus bars of 0.002 inches thick by 7.0 inches long and 0.5 inches wide were laid across the exposed heater fabric, and the assembly was placed within a vacuum bag (not shown). The assembly was subjected to a voltage via a PID type temperature controller and power supply sufficient to raise the structure's temperature at a rate of 3° C. per minute, as measured by a thermocouple placed on the exterior surface. The thermocouple had been referenced to the internal bondline temperature during prior tests. The temperature rise was continue until 120° C. was reached, at which the assembly was maintained at this temperature for one hour. Cool down was performed by natural convention and radiation and proceeded until room temperature was reached, at which time the assembly was removed from the bag and the edges trimmed.

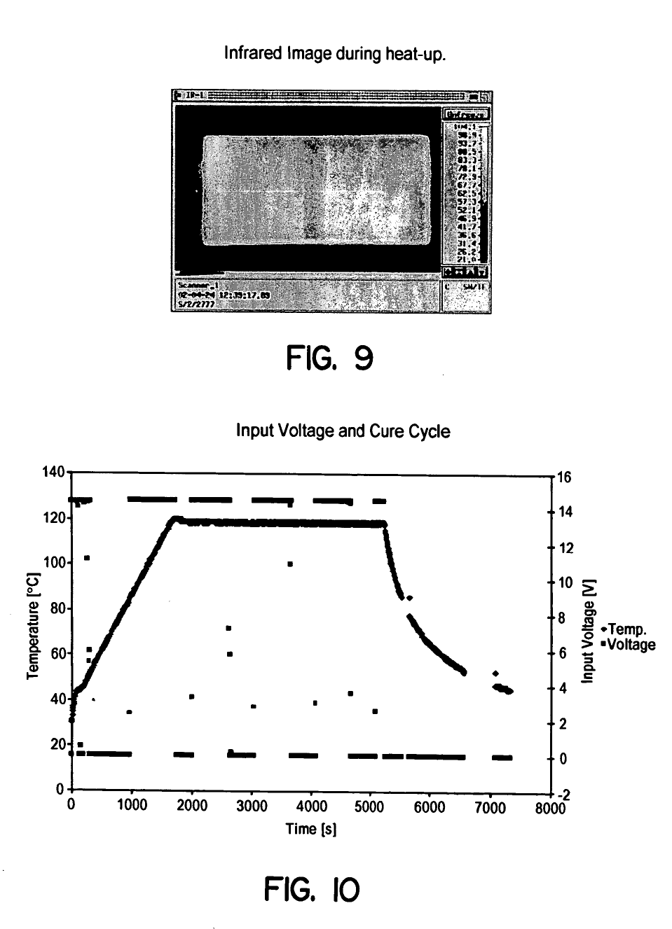

FIG. 2 illustrates the construction details, while FIGS. 9 and 10 show the temperature profile and cycle, respectively, of the upper surface during the temperature ramp-up. FIG. 9 shows the infrared image of the bondline during heat-up to 120° C. As shown in FIG. 9, the infrared image is homogeneous and symmetrical, which indicates even heating of the adhesive during curing. FIG. 10 shows a graphic illustration of the experiment which shows the input voltage during the curing cycle. As seen in FIG. 10, the maximal curing temperature for the adhesive used can be achieved quickly and curing of the adhesive can be achieved in less than an hour.

What is claimed is:

1. A method for bonding structures having at least one bondline, wherein the method comprises:
applying a first adhesive layer on the surface of a first structure to be bonded;
applying a fabric heater on the adhesive layer on the surface of the first structure, wherein the fabric heater comprises an electrically conductive fabric, two bus bars, and leads for connecting to a power source;
applying a second adhesive layer on the surface of a second structure to be bonded;
contacting the second adhesive layer on the surface of the second structure with the exposed surface of the fabric heater on the first structure so that the fabric heater is sandwiched between the first and second adhesive layers on the first and second structures to form the bondline, and
energizing the fabric heater to raise the temperature at the bondline to the curing temperature of the adhesive; wherein the fabric heater becomes part of the bonded structures after curing.

2. The method of claim 1, wherein the electrically conductive fabric is a non-woven fabric.

3. The method of claim 1 or 2, wherein the electrically conductive fabric comprises carbon fibers.

4. The method of claim 3, wherein the fabric or the carbon fibers are coated with a metal.

5. The method of claim 4, wherein the metal is selected from the group consisting of nickel, brass, and silver.

6. The method of claim 1, wherein the bus bars are made from a metal selected from the group consisting of copper, brass and silver.

7. The method of claim 6, further comprising a conductive adhesive for attaching the bus bars to the fabric heater.

8. The method of claim 1 or 2, wherein the fabric heater further comprises an organic or inorganic binder.

9. The method of claim 8, wherein the organic binder is a thermosetting polyester.

10. The method of claim 8, wherein the inorganic binder is an alumina sol.

11. The method of claim 1, further comprising treating the surface of the first and second structures to be bonded with a surface treatment to prevent electrical shorting and/or to aide adhesion.

12. The method of claim 1, wherein the surfaces of the first and the second structures to be bonded are electrically conductive.

13. The method of claim 1 or 12, further comprising disposing at least one layer of a thin non-conductive fabric layer on the surfaces of first and second structures to be bonded prior to applying the adhesive layers to form a dielectric layer.

14. A method for bonding structures having at least one bondline, wherein the method comprises:
applying a heater element to the bonding surfaces of at least two structures to be bonded, wherein the heater comprises an electrically conductive fabric, two bus bars, and the heater is pre-impregnated with an adhesive;
contacting electrical leads to the bus bars and connecting the electrical leads to a power source, wherein the heater is sandwiched between the structures to be bonded, and
energizing the heater to produce heat evenly throughout the adhesive and to increase the local temperature of the bondline to the curing temperature of the adhesive; wherein the heater element becomes part of the bonded structure after curing.

15. The method of claim 14, wherein the bus bars and heater element are pre-impregnated with the adhesive.
